(19) United States
(12) Patent Application Publication
(10) Pub. No.: US 2025/0196177 A1
(43) Pub. Date: Jun. 19, 2025

(54) MODULAR MANIFOLD UNIT

(71) Applicant: Woodster Capital, Ltd., Chardon, OH (US)

(72) Inventors: Mark RUNDO, Washington, DC (US); Matthew Christopher RUNDO, Washington, DC (US)

(21) Appl. No.: 18/541,205

(22) Filed: Dec. 15, 2023

(51) Int. Cl. B05C 5/02

(52) U.S. Cl. CPC B05C 5/0275

(57) ABSTRACT

A manifold unit includes a body that defines a first inlet aperture having a first inlet axis; a second inlet aperture having a second inlet axis substantially coincident with the first inlet axis; a first outlet aperture having a first outlet axis substantially perpendicular to the first and second inlet axes; and a second outlet aperture having a second outlet axis substantially perpendicular to the first and second inlet axes. The second outlet axis is substantially coplanar with the first outlet axis.

### FIELD OF THE INVENTION

This application generally relates to a modular manifold unit, and more specifically, a modular manifold unit that can be used to form a manifold system of a multi-bead applicator.

### BACKGROUND

The present disclosure relates to a modular manifold unit for a multi-bead applicator that can be used to apply adhesive or other fluids along a surface in a plurality of beads. There are a number of circumstances where an apparatus for concurrently applying a plurality of beads of a substance can be advantageously employed. For example, when constructing roofs for commercial or industrial buildings, adhesives are commonly used to secure various layers of roofing materials together. It is highly desirable that an apparatus be available that can rapidly apply large volumes of the adhesive to a relatively wide section of a roof in a single pass of the apparatus over the roofing materials. Thus, it can be desirable to have an applicator that simultaneously applies multiple, spaced apart, beads of adhesive along the roof in a single pass. Moreover, it may be advantageous to have an applicator that applies a two-part adhesive formed by mixing two-adhesive reactants.

One example multi-bead applicator of the prior art is illustrated in FIG. 9 of the present disclosure. The applicator includes first and second manifold systems 302A, 302B, which each include an inlet (not shown) and a plurality of outlets 304A, 304B in communication with the inlet. The applicator further includes a plurality of nozzles 378, wherein each nozzle 378 is fluidly coupled to a pair of associated outlets 304A, 304B via associated fluid lines 308A, 308B. The inlets of the manifold systems 302A, 302B can be fluidly coupled to respective fluid sources, such that a first fluid can be delivered to the nozzles 378 via the first manifold system 302A and the first set of fluid lines 308A, and a second fluid can be delivered to the nozzles 378 via the second manifold system 302B and the second set of fluid lines 308B.

However, the manifold systems 302A, 302B are not customizable for different applications requiring a different number of nozzles 378 and corresponding manifold outlets 304A, 304B. Moreover, due to the configuration and alignment of the manifold systems 302A, 302B and their outlets 304A, 304B, the fluid lines 308A, 308B must cross each other to fluidly couple every nozzle 378 to each manifold system 302A, 302B, leading to a complicated and tangled arrangement of fluid lines 308A, 308B. Furthermore, the fluid line 308A, 308B from one nozzle 378 to a manifold system 302A, 302B may be significantly longer than the fluid line 308A, 308B from the same to nozzle 378 to the other manifold system 302A, 302B (e.g., the fluid line 308B from the far-left nozzle 378 to the second manifold system 302B extends a farther distance than the fluid line 308A from the same nozzle 378 to the first manifold system 302A). This can result in uneven flow of the first and second fluids to the nozzles 378, since the fluids must flow different distances thereto.

### SUMMARY OF THE INVENTION

In accordance with a first aspect, a manifold unit includes a body that defines a first inlet aperture having a first inlet axis; a second inlet aperture having a second inlet axis substantially coincident with the first inlet axis; a first outlet aperture having a first outlet axis substantially perpendicular to the first and second inlet axes; and a second outlet aperture having a second outlet axis substantially perpendicular to the first and second inlet axes. The second outlet axis is substantially coplanar with the first outlet axis.

In accordance with a second aspect, manifold system includes a plurality of manifold units, wherein each manifold unit includes a body that defines a first inlet aperture having a first inlet axis; a second inlet aperture having a second inlet axis substantially coincident with the first inlet axis; a first outlet aperture having a first outlet axis substantially perpendicular to the first and second inlet axes; and a second outlet aperture having a second outlet axis substantially perpendicular to the first and second inlet axes. The second outlet axis is substantially coplanar with the first outlet axis.

### BRIEF DESCRIPTION OF THE DRAWINGS

These and other features, aspects and advantages of the present disclosure can be further understood when read with reference to the accompanying drawings, wherein:

FIG. 1 is a perspective view of an example modular manifold unit;

FIG. 2 is a front view of the manifold unit;

FIG. 3 is a left side view of the manifold unit;

FIG. 4 is a front view of an example manifold system that is assembled using the manifold unit;

FIG. 5 is a top view of the manifold system;

FIG. 6 is a schematic top view of an example multi-bead applicator that includes the manifold system;

FIG. 7 is a front view of the manifold unit according to a second embodiment;

FIG. 8 is a left side view of the manifold unit according to the second embodiment; and

FIG. 9 is a schematic view of an example multi-bead applicator of the prior art.

### DETAILED DESCRIPTION

The following is a detailed description of illustrative embodiments of the present application. As these embodiments of the present application are described with reference to the aforementioned drawings, various modifications or adaptations of the methods and or specific structures described may become apparent to those skilled in the art. All such modifications, adaptations, or variations that rely upon the teachings of the present application, and through which these teachings have advanced the art, are considered to be within the spirit and scope of the present application. Hence, these descriptions and drawings are not to be considered in a limiting sense as it is understood that the present application is in no way limited to the embodiments illustrated.

Moreover, certain terminology is used herein for convenience only and is not to be taken as a limitation. For example, relative directional terms herein such as “front”, “rear”, “top”, “bottom”, “left”, “right”, and the like are used for convenience when describing the embodiments as oriented in the drawings. Such orientation(s), however, are arbitrary, and different orientations can result rearranging which feature might be considered the “left” or “right,” etc.

Furthermore, the term “substantially” is intended to note that the described features are equal or approximately equal to a value or characteristic, as desired, reflecting tolerances, conversion factors, rounding off, measurement error and the like, and other factors. The term is also utilized herein to represent the degree by which a quantitative representation may vary from a stated reference without resulting in a change in the basic function of the subject matter at issue. For example, two features that are “substantially parallel” or “substantially perpendicular” can denote features that are within about 10° of exact, for example within about 5° of exact, or within about 2° of exact. As another example, two features that are “substantially coplanar” or “substantially coincident” can denote features that are similarly angled from exact and/or offset from exact by a nominal distance such as about ⅛ inch or less, for example about 1/16 inch or less. As yet another example, two features that are “substantially equidistant” or the like can denote features that are within about 10% of exact, for example within about 5% of exact, or within about 2% of exact. When the term “substantially” is used in describing a value or characteristic, the disclosure should be understood to include the exact value or characteristic being referred to.

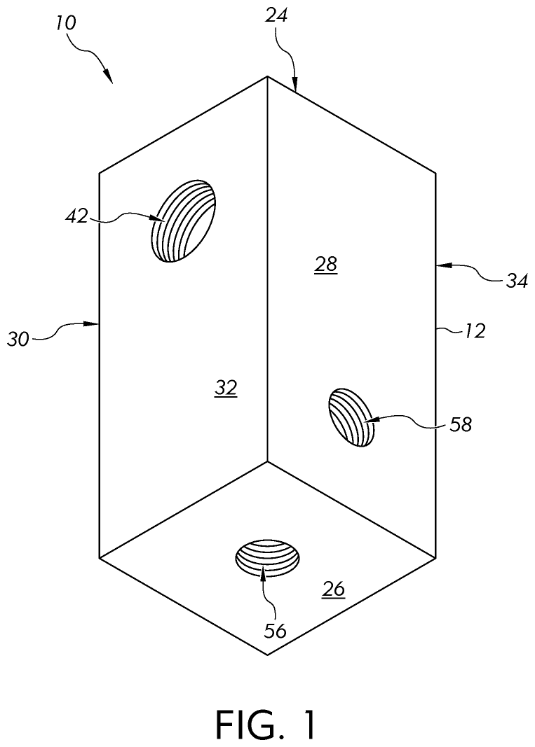

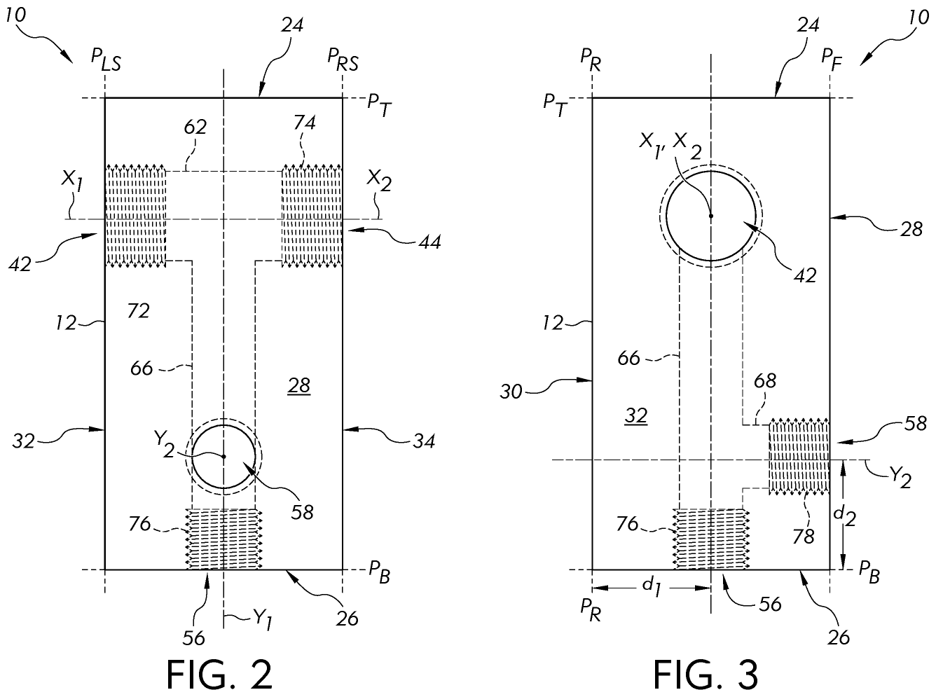

Turning to FIGS. 1-3, an example manifold unit 10 will now be described that can form part of a manifold system for a multi-bead applicator. FIG. 1 shows a perspective view of the manifold unit 10, while FIGS. 2 and 3 respectively show front and left side views of the manifold unit 10.

The manifold unit 10 comprises a monolithic body 12 of material (e.g., aluminum, stainless steel, etc.) having a substantially cuboid shape with a top surface 24 that extends along a top plane P_{T}; a bottom surface 26 opposite to the top surface 24 that extends along a bottom plane P_{B} substantially parallel to the top plane P_{T}; a front surface 28 that extends along a front plane P_{F}; a rear surface 30 opposite to the front surface 28 that extends along a rear plane P_{R} substantially parallel to the front plane P_{F}; a left-side surface 32 that extends along a left-side plane P_{LS}; and a right-side surface 34 opposite to the left-side surface 32 that extends along a right-side plane PRS substantially parallel to the left-side plane P_{LS}. The top and bottom planes P_{T,B} are each substantially perpendicular to the other planes P_{F,R,LS,RS}. Moreover, the front and rear planes P_{F,R} are each substantially perpendicular to the left- and right-side planes P_{LS,RS}.

The left- and right-side surfaces 32, 34 of the body 12 respectively define first and second inlet apertures 42, 44 having first and second inlet axes X₁, X₂ that are substantially coincident with each other, while the bottom and front surfaces 26, 28 respectively define first and second outlet apertures 56, 58 having first and second outlet axes Y₁, Y₂ that are substantially coplanar and perpendicular to the first and second inlet axes X₁, X₂. In particular, the first outlet axis Y₁ intersects with the first and second inlet axes X₁, X₂, while the second outlet axis Y₂ intersects with and is substantially perpendicular to the first outlet axis Y₁.

The first and second inlet apertures 42, 44 and the first outlet aperture 56 are all substantially centered between the front and rear planes P_{F,R}, while the first and second outlet apertures 56, 58 are both substantially centered between the left- and right-side planes P_{LS, RS}. Put another way, the first and second inlet axes X₁, X₂ and first outlet axis Y₁ are substantially centered between and parallel to the left- and right-side planes P_{LS, RS}, while the first and second outlet axes Y₁, Y₂ are substantially centered between and parallel to the left- and right-side planes P_{LS}, RS. Moreover, the first outlet axis Y₁ of the first outlet aperture 56 is spaced a first distance d₁ from the rear plane P_{R}, while the second outlet axis Y₂ of the second outlet aperture 58 is spaced a second distance d₂ from the bottom plane P_{B}, the first and second distances d_{1,2} being substantially equal to each other.

The body 12 further defines an inlet channel 62 that extends from the first inlet aperture 42 to the second inlet aperture 44, a first outlet channel 66 that extends from the inlet channel 62 to the first outlet aperture 56, and a second outlet channel 68 that extends from the first outlet channel 66 to the second outlet aperture 58. In the present embodiment, the inlet channel 62 extends along and is concentric with the first and second inlet axes X₁, X₂. Moreover, the first and second outlet channels 66, 68 respectively extend along and are concentric with the first and second outlet axes Y₁, Y₂. However, the channels 62, 66, 68 may have other arrangements without departing from the scope of the disclosure. In one example, the inlet channel 62 can be a V-shaped channel that connects the first and second inlet apertures 42, 44 with the first outlet channel 66.

The inlet channel 62 in the present example has an internal diameter of ½ inch while the outlet channels 66, 68 have an internal diameter of ⅜ inch. Moreover, each channel 62, 66, 68 is at least partially threaded at a portion adjacent to its associated inlets or outlet. For example, in the present embodiment, the inlet channel 62 has a first set of inlet threads 72 adjacent to the first inlet aperture 42 and a second set of inlet threads 74 adjacent to the second inlet aperture 44. Moreover, the first and second outlet channels 66, 68 respectively have first and second sets of outlet threads 76, 78 adjacent to the first and second outlet apertures 56, 58.

As can be seen in FIGS. 2 and 3, the inlet and first outlet channels 62, 66 are configured such that the flow paths from the first and second inlet apertures 42, 44 to the first outlet channel 66 are substantially equidistant. Likewise, the first and second outlet channels 66, 68 are configured such that the flow paths from the inlet channel 62 to the first and second outlet apertures 56, 58 are substantially equidistant. That is, a first flow path from the inlet channel 62 to the first outlet aperture 56 has substantially the same distance as a second flow path from the inlet channel 62 to the second outlet aperture 58. In this manner, the manifold unit 10 can provide a similar path between either inlet aperture 42, 44 and either outlet aperture 56, 58.

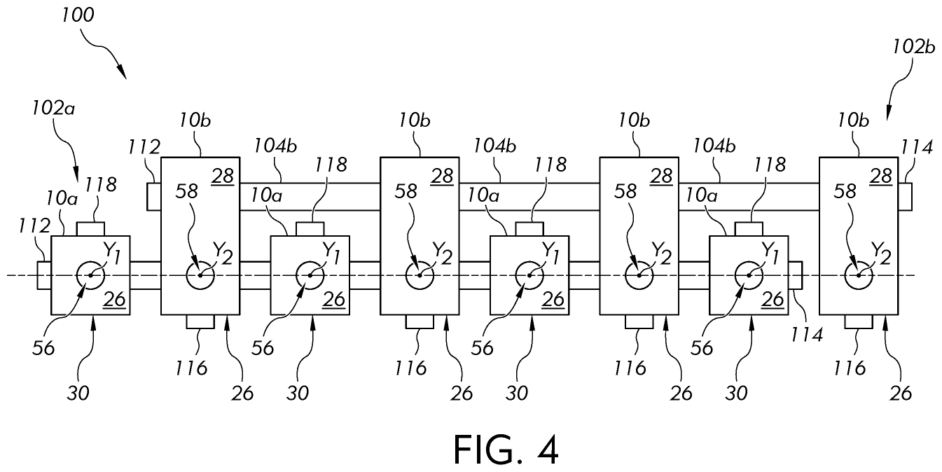

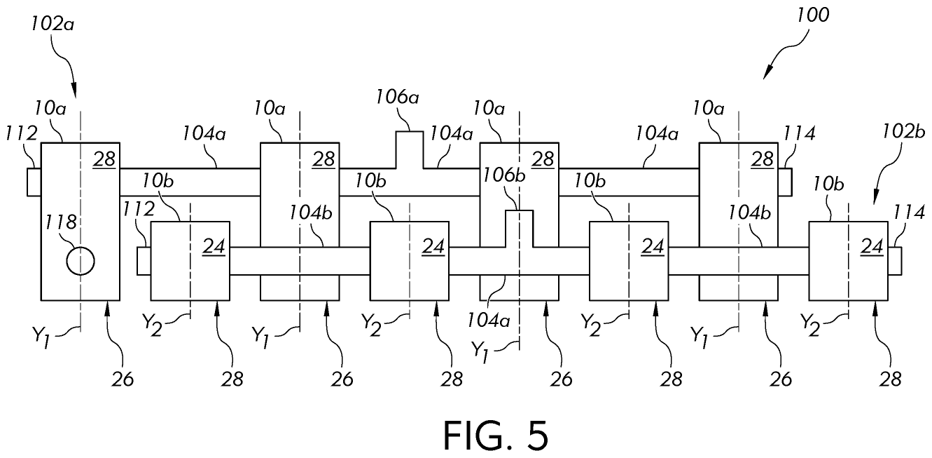

Turning to FIGS. 4 and 5, and example manifold system 100 will now be described that can be assembled using the manifold unit 10 described above. FIG. 4 shows a front view of the manifold system 100 while FIG. 5 shows a top view of the manifold system 100.

The manifold system 100 has a first sub-system 102a comprising a set of first manifold units 10a, wherein each manifold unit 10a is arranged in a horizontal configuration such that its front and rear surfaces 28, 30 are horizontal. The manifold system 100 further includes a second sub-system 102b comprising a set of second manifold units 10b, wherein each manifold unit 10b is arranged in a vertical configuration such that its front and rear surfaces 28, 30 are vertical.

The manifold units 10a, 10b of each sub-system 102a, 102b are aligned and fluidly coupled via a plurality of coupling elements 104a, 104b. In particular, each pair of fluidly coupled manifold units 10a, 10b has an associated coupling element 104a, 104b with one end that is threadably inserted through the first inlet aperture 42 of one manifold unit 10a, 10b, and another end that is threadably inserted through the second inlet aperture 44 of the other manifold unit 10a, 10b. Each coupling element 104a, 104b can be a tube (e.g., pipe, hose, etc.) or some other fluid coupler that can convey fluid between its associated manifold units 10a, 10b. Moreover, one or more of the coupling elements 104a, 104b can have an inlet 106a, 106b for fluidly coupling its associated sub-system 102a, 102b to a fluid source.

The manifold units 10a, 10b of the first and second sub-systems 102a, 102b are alternately aligned such that the bottom surfaces 26 of the first manifold units 10a and the front surfaces 28 of the second manifold units 10b are substantially coplanar (see FIG. 5), while the rear surfaces 30 of the first manifold units 10a and the bottom surfaces 26 of the second manifold units 10b are also substantially coplanar (see FIG. 4). By this configuration, the first outlet apertures 56 of the first manifold units 10a and the second outlet apertures 58 of the second manifold units 10b will be substantially coplanar. Moreover, because the distances between the rear surfaces 30 and first outlet axes Y₁ of the first manifold units 10a are substantially similar to the distances between the bottom surfaces 26 and second outlet axes Y₂ of the second manifold units 10b, the first outlet axes Y₁ of the first manifold units 10a and the second outlet axes Y₂ of the second manifold units 10b will be substantially parallel and coplanar.

Each sub-system 102a, 102b can further include one or more plugs that are threadably inserted into an inlet or outlet aperture 52, 54, 56, 58 of the sub-system. For instance, each sub-system 102a, 102b in the present embodiment has first and second plugs 112, 114 that are respectively inserted into the first and second inlet apertures 52, 54 of its end manifold units 10a, 10b. Moreover, the first sub-system 102a has a plurality of plugs 118 that are inserted into the second outlet apertures 58 of its manifold units 10a, and the second sub-system 102b has a plurality of plugs 116 that are inserted into the first outlet apertures 56 of its manifold units 10b.

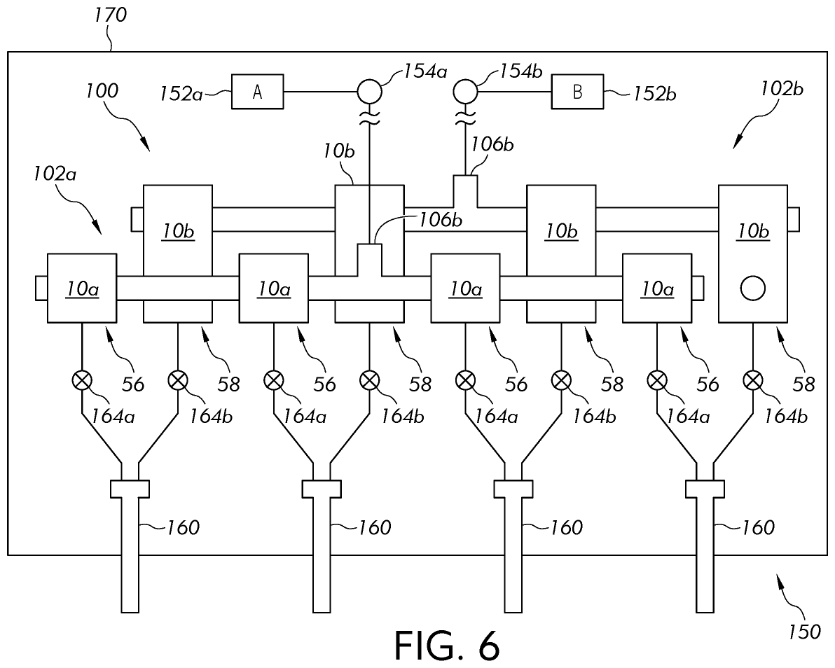

As shown schematically in FIG. 6, the manifold system 100 can be fluidly coupled with various other elements to form a multi-bead applicator 150. Specifically, the inlet 106a of the first sub-system 102a can be fluidly coupled to a first fluid source 152a that contains a first fluid A, and the inlet 106b of the second sub-system 102b can be fluidly coupled to a second fluid source 152b that contains a second fluid B. Moreover, a first pump 154a can be fluidly coupled between the first fluid source 152a and first inlet 106a, and a second pump 154b can be fluidly coupled between the second fluid source 152b and second inlet 106b. The pumps 154a, 154b are operable to convey fluid from their associated fluid sources 152a, 152b to their associated inlets 106a, 106b.

The applicator 150 can further comprise a plurality of nozzles 160, wherein each nozzle 160 is fluidly coupled to an associated outlet aperture 56 of the first sub-system 102a and an associated outlet aperture 58 of the second sub-system 102b. Moreover, a valve 164a, 164b (e.g., ball valve) can be fluidly coupled between each nozzle 160 and its associated outlet aperture 56, 58 that is operable to selectively control fluid communication therebetween.

The applicator 150 can further comprise a frame 170 that can support the elements described above. In particular, one or more elements (e.g., the manifold units 10a, 10b and nozzles 160) can be fixed in position to the frame 170 via one or more fastening elements (e.g., screws, brackets, etc.). Alternatively, one or more elements (e.g., the fluid sources 152a, 152b) can simply rest on the frame 170. The frame 170 can enable its supported elements to be conveyed together by simply moving the frame 170. In some examples, the frame 170 can be a mobile cart with wheels that can be rolled along a surface. In other examples, the frame 170 can be a wand or other handheld device that a user can grasp and move around.

In this manner, the first fluid A of the first fluid source 152a can be delivered to the inlet 106a of the first sub-system 102a and then distributed to the nozzles 160 via the first outlet apertures 56 of the first manifold units 10a and the valves 164a. Likewise, the second fluid B of the second fluid source 152b can be delivered to the inlet 106b of the second sub-system 102b and then distributed to the nozzles 160 via the second outlet apertures 58 of the second manifold units 10b and the valves 164b. The first and second fluids A, B can combine and mix within the nozzles 160, which will discharge the mixed fluids as a plurality of separate beads. Moreover, a user can move the frame 170 of the applicator 150 to discharge the beads in a desired pattern along a surface.

The modular configuration of the manifold unit 10 and its inlet and outlet apertures 42, 44, 56, 58 enables both sub-systems 102a, 102b of the applicator 150 to be assembled differently from each other using the same manifold unit 10. In particular, the sub-systems 102a, 102b can be assembled and arranged such that their operative outlet apertures 56, 58 are alternately aligned with their outlet axes Y₁, Y₂ extending along a common horizontal plane. Moreover, for each sub-system 102a, 102b, the inlet apertures 42, 44 of adjacent manifold units 10a, 10b can be fluidly coupled by an associated coupling element 104a, 104b without interference with the manifold units 10a, 10b of the other sub-system 102a, 102b. For example, as shown in FIGS. 4 and 5, the coupling elements 104a of the first sub-system 102a will pass behind the manifold units 10b of the second sub-system 102b, while the coupling elements 104b of the second sub-system 102b will pass over the manifold units 10a of the first sub-system 102a.

Furthermore, because the operative outlet apertures 56, 58 of the manifold system 100 are alternately aligned with their outlet axes Y₁, Y₂ extending along a common horizontal plane, each nozzle 160 can be fluidly coupled to its associated first and second manifold units 10a, 10b with relatively short fluid connections that are adjacent to each other along the horizontal plane. Additionally, the valves 164a, 164b fluidly coupled between the nozzles 160 and manifold units 10a, 10b can be similarly aligned along a common horizontal plane. Such horizontal alignment of the valves 164a, 164b can enable an actuation mechanism (not shown) to be easily coupled to all of valves 164a, 164b so that every valve 164a, 164b can be commonly operated simultaneously by the actuation mechanism. For example, the actuation mechanism can comprise a handle and one or more linkages that operatively couple the handle to every valve 164a, 164b so that manipulation of the handle simultaneously adjusts (e.g., opens or closes) the valves 164a, 164b.

Still further, although the sub-systems 102a, 102b of the manifold 100 are assembled differently from each other to avoid interference between their manifold units 10a, 10b and coupling elements 104a, 104b, the channel configurations of the manifold units 10a, 10b enable the sub-systems 102a, 102b to still provide the same flow path distances therethrough. As discussed above, the channels 62, 66, 68 of each manifold unit 10a, 10b are configured such that the flow paths between each inlet aperture 42, 44 and each outlet aperture 56, 58 are substantially equidistant. Consequently, the flow paths from the inlet 106a of the first sub-system 102a to its operative outlet apertures 56 will be substantially equidistant to the respective flow paths from the inlet 106b of the second sub-system 102b to its operative outlet apertures 58. This can enable the outlet apertures 56 of the first sub-system 102a and the respective outlet apertures 58 of the second sub-system 102b to provide a substantially similar flow rate of fluid, since fluid passing therethrough will travel a similar distance.

Lastly, the modular nature of the manifold unit 10 also enables other configurations of similar manifold systems with more or less manifold units 10 (and operative outlet apertures 56, 58). This can enable a user to customize the manifold system 100 and applicator 150 for different applications having different numbers of nozzles 160 and/or fluid sources 152.

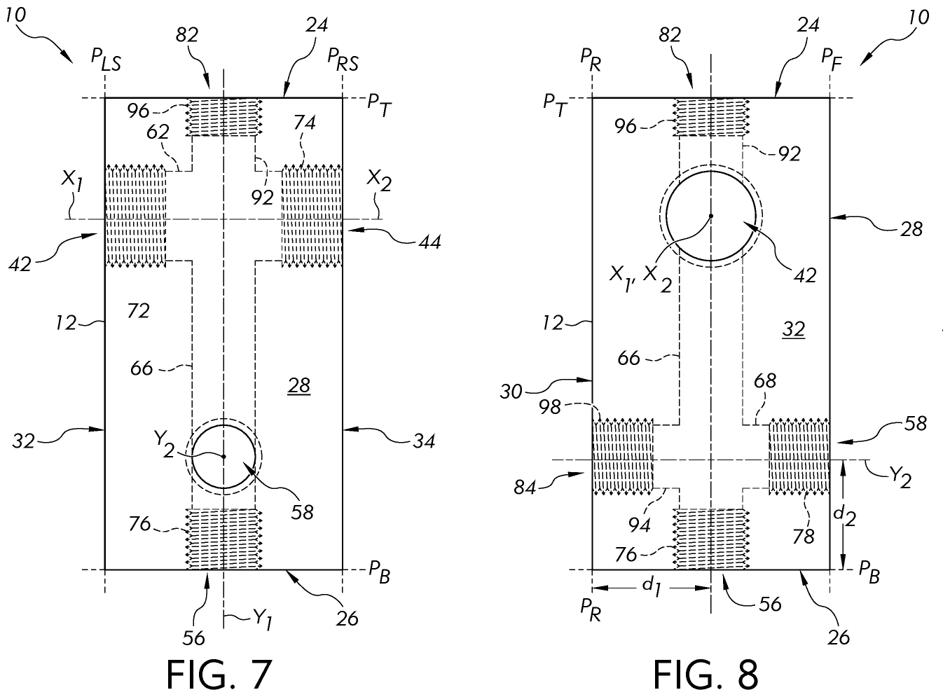

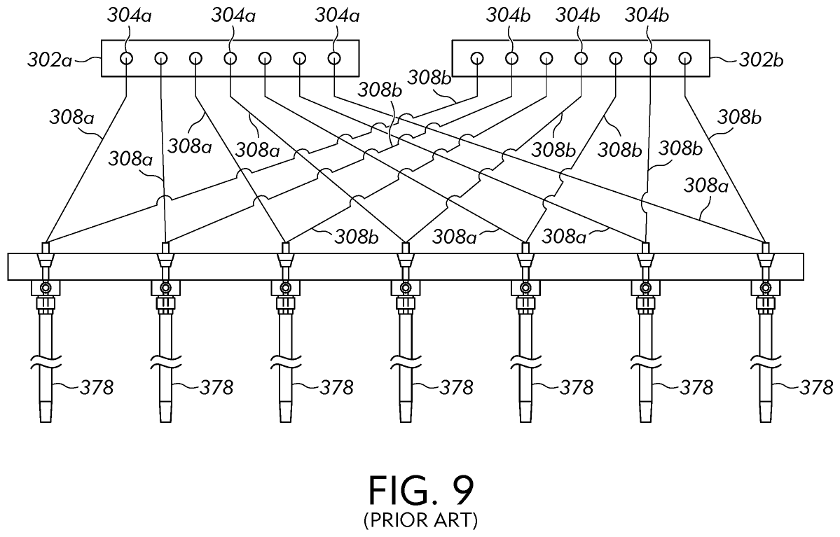

However, it is to be appreciated that the above embodiments are exemplary and various modifications and variations of the manifold unit 10 and manifold system 100 can be made to achieve similar benefits. For example, another embodiment of the manifold unit 10 is shown in FIGS. 7 and 8. The manifold unit 10 in this second embodiment is the same as in the embodiment described above except that it further includes first and second blowout apertures 82, 84 with associated blowout channels 92, 94, wherein each channel 92, 94 has a respective set of threads 96, 98. The first blowout aperture 82 and channel 92 are concentric with the outlet axis Y₁, while the second blowout aperture 84 and channel 94 are concentric with the outlet axis Y₂.

The manifold unit 10 of the second embodiment can be used for either of the sub-systems 102a, 102b described above. Moreover, the blowout apertures 82, 84 and channels 92, 94 enable a blowout system to be fluidly coupled to the manifold 10 for the purposes of cleaning out the manifold 10 and sub-system 102a, 102b after use. For example, the blowout system can include a fluid source (e.g., container) that stores a blowout fluid (e.g., air, cleaning fluid, or an inert gas such as nitrogen), and a supply line (e.g., tubing) for delivering the blowout fluid from the fluid source to the first blowout channel 92. The supply line can have an inlet fluidly coupled to the fluid source, and an outlet fluidly coupled to the first blowout channel 92 (via the threads 96).

The blowout system can further include a fluid conveyor (e.g., pump) that is operable to motivate fluid from the fluid source and into the first blowout channel 92 (via the supply line). The fluid conveyor can be upstream of the fluid source, downstream of the manifold 10, or part of the supply line. In addition or alternatively, the supply line of the blowout system can include a valve (e.g., ball valve) that can be manipulated between open and closed positions. In the open position, compressed fluid (e.g., inert gas) within the fluid source can be permitted to flow through the supply line into the first blowout channel 92, without any need for a fluid conveyor. In the closed position, the compressed fluid will be inhibited from flowing through the supply line into the first blowout channel 92.

Moreover, the blowout system can include a discharge line (e.g., tubing) that can be fluidly coupled to the second blowout channel 94 (via the threads 98) and configured to receive the blowout fluid once it passes through the manifold unit 10. Alternatively, the supply line and discharge line can be coupled in an opposite manner to the second and first blowout channels 94, 92, respectively. Still further, one line (e.g., the supply line) of the blowout system can be fluidly coupled to one of the blowout channels 92, 94, while the other line (e.g., discharge line) of the blowout system can be fluidly coupled to one of the outlet channels 66, 68 (via their associated threads 76, 78).

The manifold unit 10 of the second embodiment thus enables a blowout system to be fluidly coupled to the manifold 10 in a variety of different configurations. Moreover, if one or both of the blowout channels 92, 94 is not being utilized for the blowout system, a plug can be inserted into its associated aperture.

Other modifications of the manifold unit 10 may include other non-cuboid shapes and/or configurations of its internal channels 62, 66, 68. As another example, the first and second outlet axes Y₁, Y₂ of the manifold unit 10 may be oblique to each other but still reside along a common plane that the manifold 10 can be rotated about achieve different sub-system configurations in which the operative outlets 56, 58 of the subs-systems 102a, 102b are horizontally aligned. Indeed, it will be apparent to those skilled in the art that various modifications and variations can be made without departing from the spirit and scope of the claimed invention. It is intended to include all such modifications and alterations within the scope of the present invention.

What is claimed is:

1. A manifold unit comprising a body that defines:
a first inlet aperture having a first inlet axis;
a second inlet aperture having a second inlet axis substantially coincident with the first inlet axis;
a first outlet aperture having a first outlet axis substantially perpendicular to the first and second inlet axes; and
a second outlet aperture having a second outlet axis substantially perpendicular to the first and second inlet axes, wherein the second outlet axis is substantially coplanar with the first outlet axis.

2. The manifold unit according to claim 1, wherein the first and second outlet axes are substantially perpendicular to each other.

3. The manifold unit according to claim 1, wherein the body further defines:
an inlet channel that extends from the first inlet aperture to the second inlet aperture,
a first outlet channel that extends from the inlet channel to the first outlet aperture, and
a second outlet channel that extends from the first outlet channel to the second outlet aperture.

4. The manifold unit according to claim 3, wherein a first flow path from the inlet channel to the first outlet aperture has a first distance, and a second flow path from the inlet channel to the second outlet aperture has a second distance substantially equal to the first distance.

5. The manifold unit according to claim 3, wherein:
the inlet channel extends along the first and second inlet axes,
the first outlet channel extends along the first outlet axis, and
the second outlet channel extends along the second outlet axis.

6. The manifold unit according to claim 3, wherein the inlet channel, first outlet channel, and second outlet channel are at least partially threaded.

7. The manifold unit according to claim 6, wherein:
the inlet channel includes a first set of inlet threads adjacent to the first inlet aperture and a second set of inlet threads adjacent to the second inlet aperture,
the first outlet channel has a first set of outlet threads adjacent to the first outlet aperture, and
the second outlet channel has a second set of outlet threads adjacent to the second outlet aperture.

8. The manifold unit according to claim 1, wherein the body comprises:
a top surface extending along a top plane,
a bottom surface opposite to the top surface that extends along a bottom plane, the bottom surface defining the first outlet aperture,
a front surface extending along a front plane, the front surface defining the second outlet aperture,
a rear surface opposite to the front surface, the rear surface extending along a rear plane,
a left surface extending along a left plane, the left surface defining the first inlet aperture, and
a right surface opposite to the left surface that extends along a right plane, the right surface defining the second inlet aperture.

9. The manifold unit according to claim 8, wherein a first distance from the rear plane to the first outlet axis is substantially equal to a second distance between the bottom plane and the second outlet axis.

10. The manifold unit according to claim 8, wherein the first outlet aperture and second outlet aperture are substantially centered between the left plane and right plane.

11. A manifold system comprising a plurality of manifold units, wherein each manifold unit comprises a body that defines:
a first inlet aperture having a first inlet axis;
a second inlet aperture having a second inlet axis substantially coincident with the first inlet axis;
a first outlet aperture having a first outlet axis substantially perpendicular to the first and second inlet axes; and
a second outlet aperture having a second outlet axis substantially perpendicular to the first and second inlet axes, wherein the second outlet axis is substantially coplanar with the first outlet axis.

12. The manifold system according to claim 11, wherein the plurality of manifold units comprises a set of manifold units fluidly coupled together and arranged such that the first outlet axes of the set of manifold units are substantially parallel and substantially coplanar.

13. The manifold system according to claim 11, wherein the plurality of manifold units comprises a first manifold unit and a second manifold unit arranged such that the first outlet axis of the first manifold unit and the second outlet axis of the second manifold unit are substantially parallel and substantially coplanar.

14. The manifold system according to claim 11, wherein the body of each manifold unit comprises:
a top surface extending along a top plane,
a bottom surface opposite to the top surface that extends along a bottom plane, the bottom surface defining the first outlet aperture,
a front surface extending along a front plane, the front surface defining the second outlet aperture,
a rear surface opposite to the front surface, the rear surface extending along a rear plane,
a left surface extending along a left plane, the left surface defining the first inlet aperture, and
a right surface opposite to the left surface that extends along a right plane, the right surface defining the second inlet aperture.

15. The manifold system according to claim 14, wherein the plurality of manifold units comprises a first manifold unit and a second manifold unit arranged such that the bottom surface of the first manifold unit and the front surface of the second manifold unit are substantially coplanar.

16. The manifold system according to claim 11, wherein the plurality of manifold units comprises:
a set of first manifold units fluidly coupled together, and
a set of second manifold units fluidly coupled together,
wherein the first manifold units and second manifold units are arranged such that the first outlet axes of the first manifold units and the second outlet axes of the second manifold units are substantially parallel and substantially coplanar.

17. The manifold system according to claim 16, wherein the body of each manifold unit comprises:
a top surface extending along a top plane,
a bottom surface opposite to the top surface that extends along a bottom plane, the bottom surface defining the first outlet aperture,
a front surface extending along a front plane, the front surface defining the second outlet aperture,
a rear surface opposite to the front surface, the rear surface extending along a rear plane,
a left surface extending along a left plane, the left surface defining the first inlet aperture, and
a right surface opposite to the left surface that extends along a right plane, the right surface defining the second inlet aperture.

18. The manifold system according to claim 17, wherein the first manifold units and second manifold units are arranged such that the bottom surfaces of the first manifold units and the front surfaces of the second manifold units are substantially coplanar.
